(19) United States
(12) Patent Application Publication
(10) Pub. No.: US 2010/0050962 A1
(43) Pub. Date: Mar. 4, 2010

(54) Flexible tongue valve for an oil separation device in the crankcase ventilation of a motor vehicle

(76) Inventors: Lasse Hoffmann, Winsen (DE); Artur Knaus, Hamburg (DE)

Correspondence Address: MCCRACKEN & FRANK LLP, 311 S. WACKER DRIVE, SUITE 2500, CHICAGO, IL, 60606, US

(21) Appl. No.: 12/459,139

(22) Filed: Jun. 26, 2009

(30) Foreign Application Priority Data
Jul. 7, 2008 (DE) 10 2008 031 544.3

(51) Int. Cl. F01M 13/04; F16K 17/38

(52) U.S. Cl. 123/41.86; 137/468

(57) ABSTRACT

A flexible tongue valve for an oil separation device in the crankcase ventilation of a motor vehicle includes a flexible tongue which on one end is suspended in a cantilevered manner and on the opposite end interacts with a valve seat. The flexible tongue comprises a bistable portion with a first stable position and a second stable position, wherein the bistable portion consists of a bimetal and is adapted to automatically abruptly switch between the first stable position and the second stable position depending on temperature.

### BACKGROUND OF THE INVENTION

1. Field of the Invention

The invention relates to a flexible tongue valve for an oil separation device in the crankcase ventilation of a motor vehicle.

2. Description of the Background of the Invention

Flexible tongue valves are used to fulfil different functions of oil separation devices in the crankcase ventilation of a motor vehicle. It is for example known from DE 10 2004 006 082 A1 to automatically switch on or off parallel-connected cyclone separators in a separation device depending on the gas volume by means of a flexible tongue valve located on the outside of the gas outlet tube. DE 103 20 215 B4 discloses a flexible tongue impactor separator comprising a flexible tongue located in the separation chamber at the gas inlet and a downstream deflecting wall. It is also known to use a flexible tongue valve for the oil drain opening, as can be seen for example in DE 296 05 425 U1 and DE 10 2004 061 938 B3. However, there are some concerns with respect to protection against freezing in connection with flexible tongue valves in crankcase ventilation. At ambient temperatures below the freezing point not only parked vehicles in particular run the risk of condensate separated from the crankcase gases, consisting of a mixture of oil, fuel and water, freezing in the return lines and blocking the same. Otto engines, in which crankcase ventilation is effected according to the PCV principle, due to the high humidity of the air introduced for ventilation further run the risk of movable components or small cross sections freezing and thus being blocked as well.

From DE 10 2004 055 065 A1 an oil separation device is known, which comprises at least one oil separator and a parallel-connected by-pass line in which a by-pass valve is located, which by-pass valve switches depending on temperature in particular by means of a bimetal element. At low ambient temperatures the by-pass valve opens in order to allow a crankcase ventilation through the by-pass line, even with frozen separator for example during cold starting. When the oil separation device warms up the by-pass valve closes again. However, this might lead to problems as it may possibly take a long time until a once frozen separator is operational again.

### SUMMARY OF THE INVENTION

It is the object of the invention to provide a flexible tongue valve for an oil separation device wherein protection against freezing is achieved with simple means.

The invention solves this object with the features of claim 1. By using a bimetal flexible tongue, such a flexible tongue valve can open wide enough without auxiliary power so that the separated oil is able to essentially drain off completely and thus can no longer freeze, and the flexible tongue is prevented from freezing to the valve seat. The invention thus concerns the flexible tongue valve of the oil separator itself in order to prevent oil in the oil separator from freezing right from the start. A by-pass line for bypassing a frozen oil separator then is no longer necessary.

According to the invention, the flexible tongue comprises a bistable portion with a first stable position and a second stable position, wherein for functional reasons the flexible tongue valve in the second stable position is opened to a wider extent compared to the first stable position. This enables the flexible tongue valve to abruptly open when the temperature falls below a defined temperature so that separated oil can be prevented from freezing in the oil separator right from the start. As soon as an ambient temperature no longer bearing the risk of freezing is reached the bistable portion switches back to the first stable (normal) position and the separation process can be continued without delay.

The positions between the first stable position and the second stable position are unstable and abruptly switch over to one of the stable positions. The bistable valve comprising two stable positions only provides substantial advantages compared to a bimetal strip continuously bending. In particular, the flexible tongue remains in the first stable (normal) position until the switching temperature is reached so that a temperature-sensitive opening width of the flexible tongue valve at temperatures above the switching temperature is avoided. Furthermore, at high ambient temperatures the pressing force of the flexible tongue applied to the valve seat remains constant, whereas with a continuously bending bimetal strip the pressure force resulting from the bimetal effect might reach such a high level that the valve possibly no longer opens.

The bistable design of the flexible tongue in particular is achieved by the bimetal flexible tongue not being stamped out of one flat sheet metal but by its cross section having a curved form, whereby the favourable step function is achieved.

In the following, the invention is described in more detail on the basis of preferred embodiments referring to the attached figures. These figures show:

### BRIEF DESCRIPTION OF THE DRAWINGS

FIG. 1: a cross-sectional view of a flexible tongue valve in a closed position;

FIG. 2: a cross-sectional view of the flexible tongue valve from FIG. 1 in an opened position;

FIG. 3: a top view of a flexible tongue for a flexible tongue valve;

FIG. 4: a cross-sectional view of a flexible tongue for a flexible tongue valve; and

FIG. 5: a schematic cross-sectional view of a combustion engine with a cylinder head cover.

### DETAILED DESCRIPTION OF THE DRAWINGS

The flexible tongue valve 10 is provided for example in a housing wall 11 of a cylinder head cover 12 (see FIG. 5) and includes a valve seat 13 enclosing a through opening 17 in the housing wall 11, and a flexible tongue 14, which on one end is fastened to the housing wall 11 in a cantilevered manner via a footing 28 and a retaining element 16 engaging into an opening 15 of the flexible tongue 14. For this purpose, the flexible tongue 14 comprises a basically flat fastening portion 19 on one of its ends. On the opposite end, the flexible tongue 14 comprises a valve plate portion 20 adapted to completely cover the valve seat 13.

In the central area between the fastening portion 19 and the valve plate portion 20, a switching portion 23 connected to these two portions via webs 21, 22 is provided. The switching portion 23 is formed to have a curved cross section, for example lenticular in the embodiment according to FIG. 3, and comprises two stable states, namely, the convex state shown in FIG. 1 and the concave state shown in FIG. 2. By exerting bending forces the switching portion 23 is able to abruptly switch from the convex state to the concave state and vice versa when a switching point below or above defined switching points is reached.

The flexible tongue 14 serves for the automatic control of the medium flowing through the through opening 17 depending on the pressure of said medium applied in the through opening 17 and loading the flexible tongue 14. In the example of FIGS. 1 and 2 the medium is oil-loaded blow-by gas 18 from the crankcase of a motor vehicle. However, in another application this can as well be oil separated from the blow-by gas, as will be explained in detail in connection with FIG. 5.

The state shown in FIG. 1 in which the flexible tongue 14 rests on the valve seat 13 exerting a defined pressure force in order to close the through opening 17 allocated to the valve seat 13 is taken at normal temperatures above the freezing point when the blow-by gas pressure acting upon the valve plate portion 20 of the flexible tongue 14 is not high enough to lift the flexible tongue 14, for example in case of idle engine. At a higher engine speed and with greater blow-by gas volume flow associated therewith the flexible tongue 14 is lifted against the elastic reset force of the flexible tongue 14 depending on the applied blow-by gas pressure, wherein the switching portion remains in the convex normal form shown in FIG. 1.

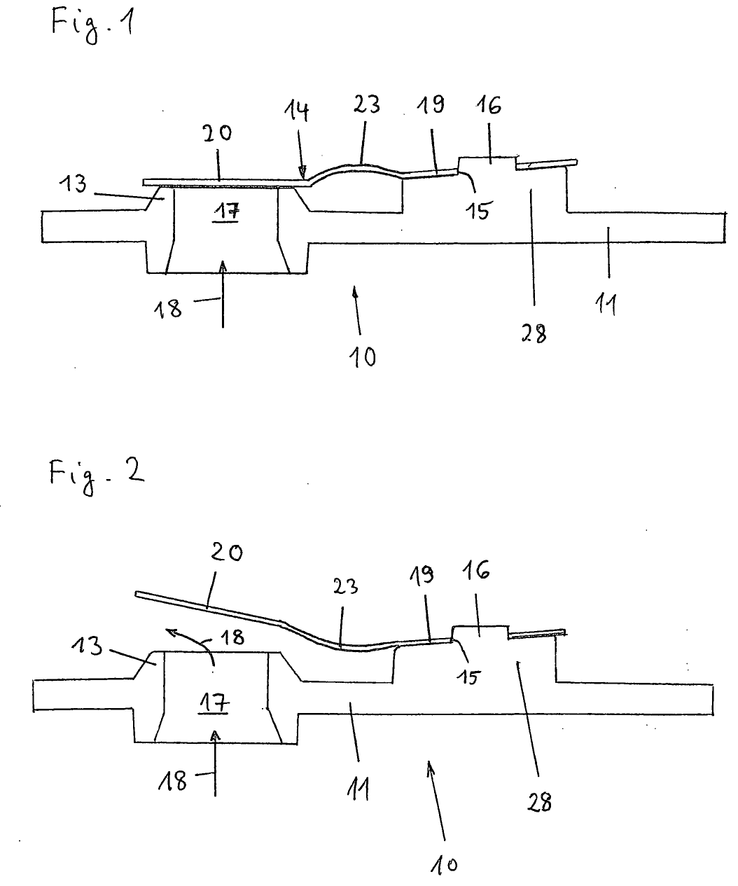

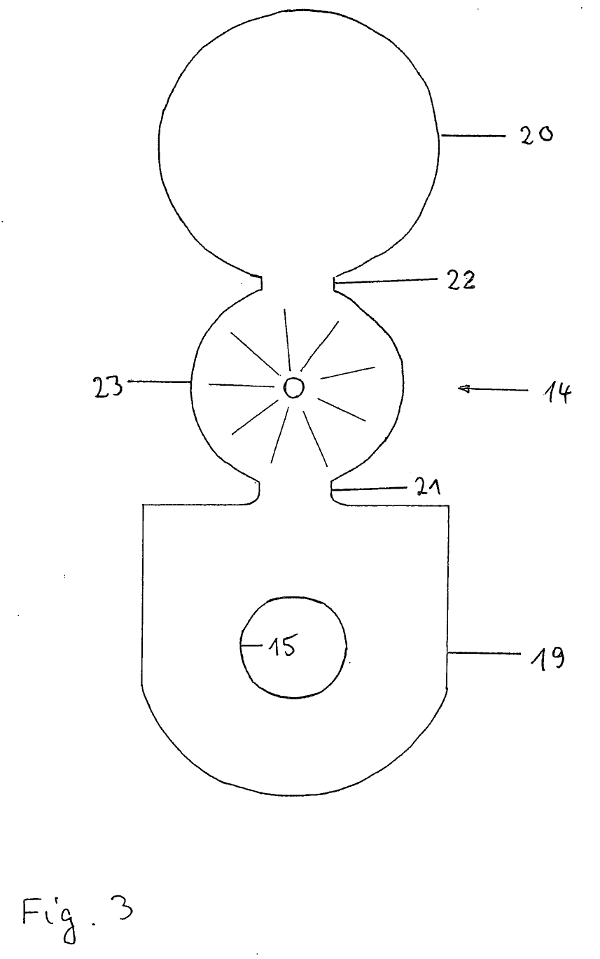

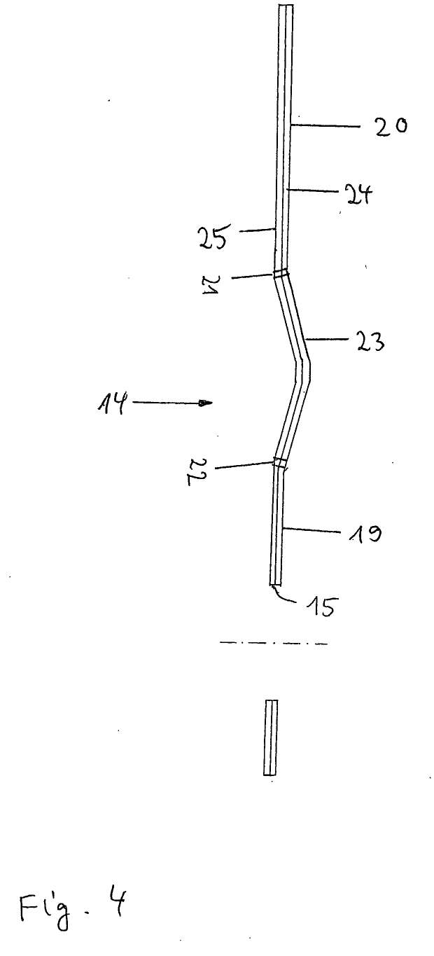

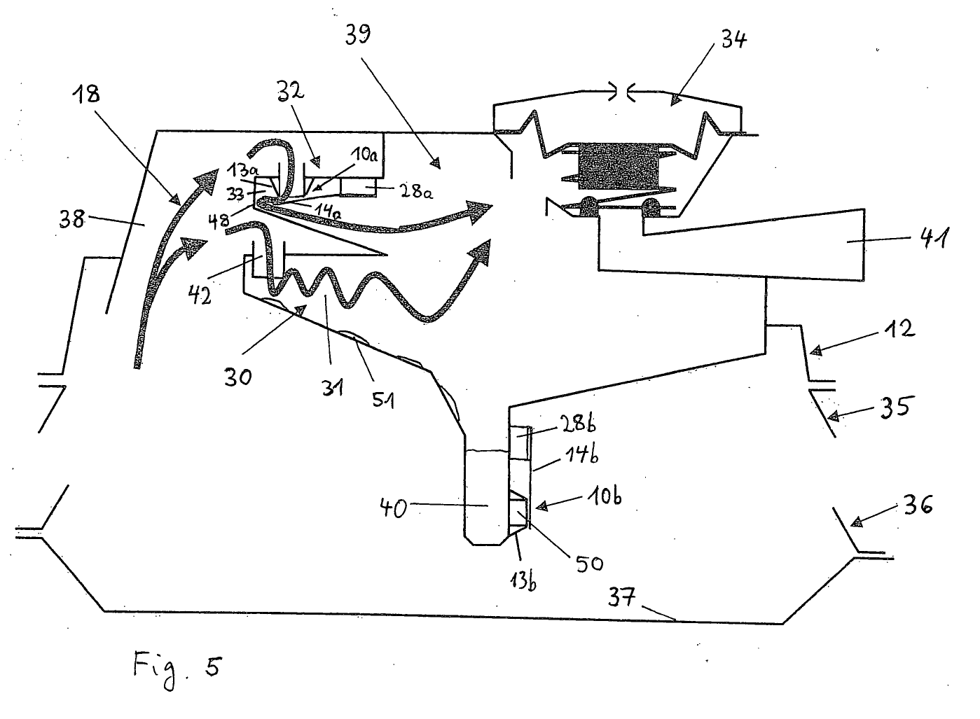

FIG. 4 shows a longitudinal cross-sectional view of the flexible tongue 14 in the convex normal form. The flexible tongue 14 consists of a bimetal strip comprising a first metal strip 24 and a second metal strip 25 having different thermal expansion coefficients. Preferably, these metal strips are two steel sheets having different thermal expansion coefficients. In particular, the metal strip 24 in the convex normal form has a higher thermal expansion coefficient on the outer surface than the metal strip 25 on the inner surface. For providing the bimetal effect, i.e. for exerting bending forces depending on temperature, the metal strips 24, 25 are in particular at their ends connected in known manner.

The bimetal strips are designed in such a way that at a normal operation temperature the switching portion 23 takes the convex form shown in FIG. 1. With falling temperatures the outer metal strip 24 contracts to a greater extent than the inner metal strip 25, whereby bending forces are exerted onto the switching portion 23 which act in the direction of the concave form, however, in the first instance, are not high enough to effectuate a switching to the concave form so that the switching portion 23 remains essentially unchanged in the convex form.

With further falling temperatures, at a defined (switching) point the bending forces are high enough to effectuate a switching of the switching portion 23 to the concave state shown in FIG. 2, wherein this switching takes place abruptly. In the concave state, the valve plate portion 20 is lifted from the valve seat 13 so that separated oil is able to drain off through the opening 17 and thus does not freeze; furthermore, the valve plate portion 20 is prevented from freezing to the valve seat 13. Expediently the switching point is chosen in the range of the freezing point of common engine oil.

With rising temperatures bending forces acting in the direction of the convex state are exerted onto the switching portion 23. When a second switching point is exceeded which expediently lies at a higher temperature than the first switching point, the bending forces effectuate an abrupt switching from the concave state according to FIG. 2 to the convex state according to FIG. 1. In this normal operation state a normal control of the volume flow depending on the applied gas pressure can be carried out again.

It is sufficient for the function described above if the switching portion 23, only, consists of bimetal. It is further possible that the two metal strips 24, 25 are connected to each other at the webs 21, 22 so that the bimetal effect occurs in the switching portion 23 only.

Basically, the thermally controlled bistable flexible tongue valve can be applied for all flexible tongue valves used in the field of crankcase ventilation of combustion engines. FIG. 5 exemplarily shows some possible applications for a bistable flexible tongue valve 10a, 10b. The shown combustion engine includes a cylinder head cover 12, cylinder head 35, crankcase 36 and oil pan 37. The cylinder head cover 12 in particular made of plastic includes a gas inlet section 38 for oil-loaded blow-by gas 18, an oil separator 30 passed through by the introduced blow-by gas 18 which comprises a gas inlet opening 42 and a swirl chamber 31 adapted to generate a gas swirl, an oil separator 32 comprising a flexible tongue valve 10a which is connected in parallel to the swirl chamber separator 30, a clean room 39 comprising an oil drain 40 which is adjacent to the oil separators 30, 32, a pressure regulating valve 34 and a gas outlet section 41. The blow-by gas is guided from the crankshaft housing 36 into the cylinder head cover 12 via ducts (not shown) provided for example in the motor housing.

In the oil separator 32 the valve seat 13a of the flexible tongue valve 10a forms the gas inlet into a separation chamber 33 comprising an inward-opening flexible tongue 14a loaded with blow-by gas which is located on the input side of said chamber. As a result of the pressure load the flexible tongue 14a clears a gap through which the blow-by gas flows at a high speed into the downstream separation chamber 33. A deflecting wall 48 is provided in the separation chamber 33 at which the gas flow entering through the gap is deflected sharply. Due to the inertia of the oil particles and dirt particles in the blow-by gas these particles are separated at the deflecting wall 48.

The separated oil 51 drains off on the bottom of the separation chamber 33, is accumulated in a reservoir 40 and is returned into the engine lubricating system through a return opening 50. The oil return opening 50 is formed by the seat 13b of a flexible tongue valve 10b with a flexible tongue 14b being located on the outside. As a result of the pressure of the oil column in the reservoir 40 the flexible tongue 14b opens and the oil is able to drain off. With the reservoir 40 being empty the flexible tongue valve 10b prevents uncleaned gas from being drawn from the engine compartment beneath the cylinder head cover 12 into the clean room 39 and the gas outlet section 41.

Further fields of application for a thermally controlled bistable flexible tongue valve are possible. For example a cyclone separator wherein the gas outlet tube is provided with a flexible tongue on the outside, can be used instead of the open swirl chamber separator 30.

We claim:

1. A flexible tongue valve for an oil separation device in the crankcase ventilation of a motor vehicle, comprising a flexible tongue which is suspended in a cantilevered manner on one end and interacts with a valve seat on the opposite end, wherein said flexible tongue comprises a bistable portion with a first stable position and a second stable position, wherein said bistable portion consists of a bimetal and is adapted to automatically switch, in an abrupt manner and depending on temperature, between said first stable position and said second stable position.

2. The flexible tongue valve according to claim 1, wherein said flexible tongue valve in said second stable position is opened to a wider extent compared to said first stable position.

3. The flexible tongue valve according to claim 2, wherein said bistable portion abruptly switches from said first stable position to said second stable position when the temperature falls below a defined temperature.

4. The flexible tongue valve according to claim 2, wherein the bistable portion abruptly switches from said second stable position to said first stable position when a defined temperature is exceeded.

5. The flexible tongue valve according to claim 1, wherein said bistable portion is formed to have a curved cross section.

6. The flexible tongue valve according to claim 1, wherein said bistable portion is located between a fastening portion and a portion interacting with the valve seat.

7. The flexible tongue valve according to claim 1, wherein said flexible tongue is adapted to continuously open said flexible tongue valve depending on the pressure of a medium acting on the flexible tongue.

8. An oil separation device for the crankcase ventilation of a motor vehicle comprising a separation chamber, a gas inlet opening for oil-loaded blow-by gas formed by a valve seat, a flexible tongue located behind the gas inlet opening in the separation chamber and interacting with the valve seat, and a downstream deflecting wall, wherein the valve seat and the flexible tongue form a flexible tongue valve, said flexible tongue being suspended in a cantilevered manner on one end and interacting with said valve seat on the opposite end, wherein said flexible tongue comprises a bistable portion with a first stable position and a second stable position, wherein said bistable portion consists of a bimetal and is adapted to automatically switch, in an abrupt manner and depending on temperature, between said first stable position and said second stable position.

9. The oil separation device according to claim 8, wherein said bistable portion abruptly switches from said first stable position to said second stable position when the temperature falls below a defined temperature.

10. The oil separation device according to claim 8, wherein the bistable portion abruptly switches from said second stable position to said first stable position when a defined temperature is exceeded.

11. The flexible tongue valve according to claim 8, wherein said bistable portion is located between a fastening portion and a portion interacting with the valve seat.

12. An oil separation device for the crankcase ventilation of a motor vehicle comprising an oil return opening formed by a valve seat and a flexible tongue interacting with the valve seat for forming a non-return valve, wherein the non-return valve is a flexible tongue valve, said flexible tongue being suspended in a cantilevered manner on one end and interacting with said valve seat on the opposite end, wherein said flexible tongue comprises a bistable portion with a first stable position and a second stable position, wherein said bistable portion consists of a bimetal and is adapted to automatically switch, in an abrupt manner and depending on temperature, between said first stable position and said second stable position.

13. The oil separation device according to claim 12, wherein said bistable portion abruptly switches from said first stable position to said second stable position when the temperature falls below a defined temperature.

14. The oil separation device according to claim 12, wherein the bistable portion abruptly switches from said second stable position to said first stable position when a defined temperature is exceeded.

15. The flexible tongue valve according to claim 12, wherein said bistable portion is located between a fastening portion and a portion interacting with the valve seat.

16. A cylinder head cover for a combustion engine, comprising an integrated oil separation device with a separation chamber, a gas inlet opening for oil-loaded blow-by gas formed by a valve seat, a flexible tongue located behind the gas inlet opening in the separation chamber and interacting with the valve seat, and a downstream deflecting wall, wherein the valve seat and the flexible tongue form a flexible tongue valve, said flexible tongue being suspended in a cantilevered manner on one end and interacting with said valve seat on the opposite end, wherein said flexible tongue comprises a bistable portion with a first stable position and a second stable position, wherein said bistable portion consists of a bimetal and is adapted to automatically switch, in an abrupt manner and depending on temperature, between said first stable position and said second stable position.

17. The cylinder head cover according to claim 16, wherein said bistable portion abruptly switches from said first stable position to said second stable position when the temperature falls below a defined temperature.

18. The cylinder head cover according to claim 16, wherein the bistable portion abruptly switches from said second stable position to said first stable position when a defined temperature is exceeded.

19. The cylinder head cover according to claim 16, wherein said bistable portion is located between a fastening portion and a portion interacting with the valve seat.

20. A cylinder head cover for a combustion engine, comprising an integrated oil separation device with an oil return opening formed by a valve seat and a flexible tongue interacting with the valve seat for forming a non-return valve, wherein said non-return valve is a flexible tongue valve, said flexible tongue being suspended in a cantilevered manner on one end and interacting with said valve seat on the opposite end, wherein said flexible tongue comprises a bistable portion with a first stable position and a second stable position, wherein said bistable portion consists of a bimetal and is adapted to automatically switch, in an abrupt manner and depending on temperature, between said first stable position and said second stable position.
